(19) United States
(12) Patent Application Publication
(10) Pub. No.: US 2010/0080368 A1
(43) Pub. Date: Apr. 1, 2010

(54) Determining a use context for a telecommunications terminal user

(75) Inventors: George William Erhart, Loveland, CO (US); Valentine C. Matula, Granville, OH (US); David Joseph Skiba, Golden, CO (US)

Correspondence Address: Avaya;DEMONT & BREYER, LLC, 100 COMMONS WAY, STE 250, HOLMDEL, NJ, 07733, US

(73) Assignee: Avaya Inc., Basking Ridge, NJ (US)

(21) Appl. No.: 12/241,906

(22) Filed: Sep. 30, 2008

(51) Int. Cl. H04M 11/00

(52) U.S. Cl. 379/93.01

(57) ABSTRACT

A technique is disclosed that addresses a problem in managing the correct context in which a telecommunications terminal is utilized by its user—that is, a work use context, a personal use context, and so forth. The disclosed technique enables the automated management of use contexts by a terminal on behalf of its user, across the possibly multiple terminals that are utilized by the user. Each terminal manages the use contexts by utilizing temporal-, schedule-, spatial-, and proximity-related information, in combination with the terminal's current and/or anticipated usage by the user, in order to establish a use context that is currently appropriate for that user at that terminal. As part of establishing a use context, the terminal makes available to its user a predetermined set of user interface properties and a predetermined set of user profile properties. Such properties can include contact lists, applications, server links, logins, and so forth.

### FIELD OF THE INVENTION

The present invention relates to telecommunications in general, and, more particularly, to determining a use context for a telecommunications terminal user, the use context comprising user interface properties and user profile properties that are to be applied to the terminal.

### BACKGROUND OF THE INVENTION

Mobile telecommunications terminals have become ubiquitous, not only in the business world, but also in the home environment. Many users not only have a terminal for work, but another terminal for personal use. Some users, in fact, have multiple terminals for work use or multiple terminals for personal use, or both. In part because of the increasing connectivity that mobile terminals provide, as well as the existence of a workforce that is itself increasingly more mobile both domestically and internationally, the hours and locations of work life and personal life are changing and merging.

### SUMMARY OF THE INVENTION

A problem exists in managing the correct context in which a telecommunications terminal is utilized by its user. Typically, this “use context” is mentally managed by the user, in that the user has to focus on which appointments, to-do items, contacts, and so forth are important at a particular moment within a work use context and which of those items are important at a different moment within a personal use context. Not surprisingly, this type of management on the part of the user is often difficult to achieve; consequently, it is often the case that the user has to retain separate mobile terminals for work use and for personal use. The problem is worse, for example, for business users who own or manage several businesses, each of which being associated with its own use context. Similarly, the problem is worse if multiple users, each with multiple use contexts, share a terminal.

The present invention comprises a technique that enables the automated management of use contexts by the terminal itself. In accordance with the illustrative embodiment of the present invention, each terminal that manages the use contexts utilizes temporal-, schedule-, spatial-, and proximity-related context information, in combination with the terminal's current and/or anticipated usage by the user, in order to establish a use context that is currently appropriate. As part of establishing a use context, the terminal of the illustrative embodiment makes available to its user a predetermined set of user interface properties and a predetermined set of user profile properties. Such properties can include contact lists, accessible applications, server links, logins, and so forth.

One example of how the terminal establishes a use context is provided here. A user of the disclosed terminal is at her residence, after typical work hours, and for the example it is assumed that the terminal is presently being used in a personal use context. She receives a phone call from her supervisor, as indicated in the caller identification information that is received with the incoming call. As a result, the terminal overrides the personal use context, and provides the user with the applications, contacts, and favorites that are needed to quickly and efficiently respond to the urgent work communication.

The illustrative embodiment comprises a method comprising: receiving i) a first indication of how a first user of a first telecommunications terminal is using or will be using the first telecommunications terminal and ii) a second indication of a spatial or temporal context that includes the first telecommunications terminal; establishing a first use context to apply to the first telecommunications terminal, based on the first indication and the second indication; and presenting a manifestation of the first use context to the first user at the first telecommunications terminal.

### BRIEF DESCRIPTION OF THE DRAWINGS

FIG. 1 depicts the salient elements of telecommunications system 100 in accordance with the illustrative embodiment of the present invention.

FIG. 2 depicts a block diagram of the salient components of telecommunications terminal 102-m, which is part of system 100.

FIG. 3 is a block diagram of how information is stored and organized in memory 203, at terminal 102-m.

FIG. 4 depicts a flowchart of the salient tasks performed, in accordance with the illustrative embodiment of the present invention.

### DETAILED DESCRIPTION

For the purposes of this disclosure, the term “communication event” and its inflected forms refers to a transmission of or an exchange of information between end-users via a telecommunications network and is defined to include:
i. a voice communication event, including but not limited to a voice telephone call or session, or
ii. a video communication event, or
iii. a textual communication event, including but not limited to instant messaging, internet relay chat, e-mail, short-message-service, Usenet-like postings, etc., or
iv. any combination of i, ii, and iii.

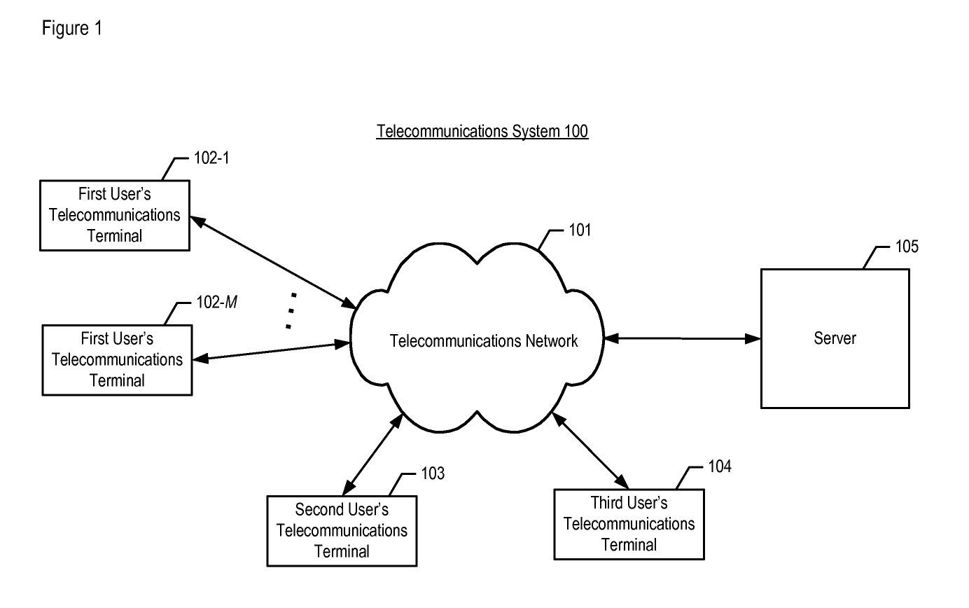

FIG. 1 depicts the salient elements of telecommunications system 100 in accordance with the illustrative embodiment of the present invention. As shown in FIG. 1, telecommunications system 100 comprises telecommunications network 101; first user's telecommunications terminals 102-1 through 102-M, wherein M is a positive integer; second user's terminal 103; third user's terminal 104; and server 105. The network elements that are depicted in FIG. 1 are interconnected as shown.

Each of telecommunications terminals 102-1 through 102-M, 103, and 104 is capable of handling one or more communications events and is well known in the art. Terminal 102-m, where m has a value between 1 and M, terminal 103, and terminal 104 are associated with a first user, a second user, and a third user, respectively. Although the illustrative embodiment comprises telecommunications terminals for three users, it will be clear to those skilled in the art, after reading this disclosure, how to make and use alternative embodiments of the present invention that comprise terminals for any number of users. And although the illustrative embodiment comprises M telecommunications terminals for the first user and one terminal for each of the second and third user, it will be clear to those skilled in the art, after reading this disclosure, how to make and use alternative embodiments of the present invention that comprise any number of terminals for each user, where each user can have the same number of terminals as each other or a different number of terminals from each other.

In accordance with the illustrative embodiment, each of telecommunications terminals 102-1 through 102-M, 103, and 104 is a wireless terminal, which communicates via one or more protocols (e.g., Code Division Multiple Access [CDMA], Institute of Electrical and Electronics Engineers [IEEE] 802.11, Bluetooth, etc.) in well-known fashion. Although the illustrative embodiment comprises all wireless terminals, it will be clear to those skilled in the art, after reading this disclosure, how to make and use alternative embodiments of the present invention that comprise any combination of wireless and wireline terminals.

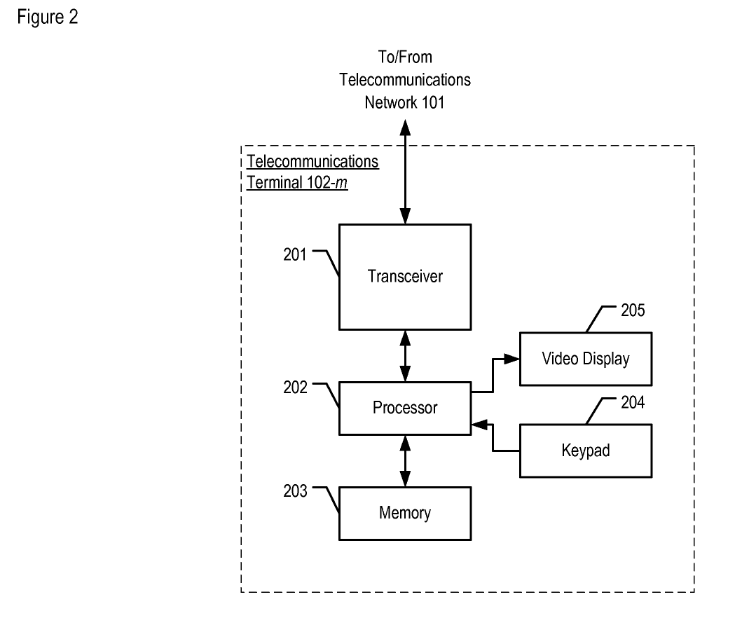

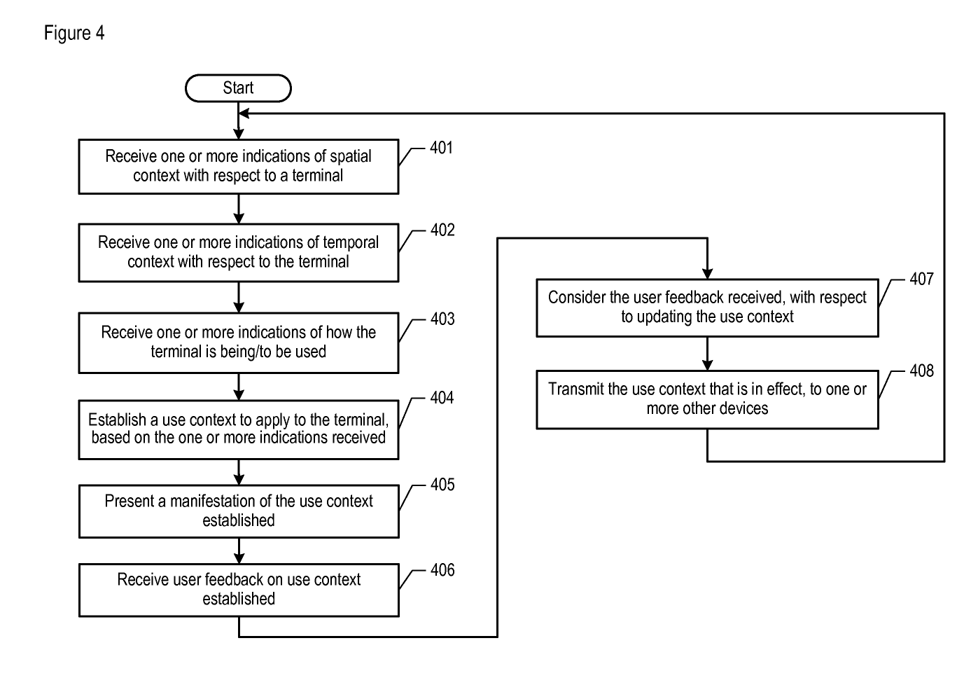

Telecommunications terminal 102-m, in particular, is one of possibly multiple terminals (i.e., terminals 102-1 through 102-M) that are associated with a single user, the components of which are described in detail below and with respect to FIG. 2. Terminal 102-m is capable of performing the tasks described below and with respect to FIG. 4, in accordance with the illustrative embodiment.

Additionally, terminal 102-m is capable of wirelessly transmitting and receiving electromagnetic signals to and from telecommunications network 101 via a wireless transceiver, in well-known fashion, and of estimating and reporting its geo-location. As will be appreciated by those skilled in the art, there are a variety of well-known techniques by which terminal 102-m can determine its geo-location based on received electromagnetic signals, such as via a Global Positioning System (GPS) receiver, via triangulation, via RF fingerprinting, and so forth. It will be clear to those skilled in the art, after reading this specification, how to make and use embodiments of the present invention for terminals that use these methods of determining geo-location, as well as embodiments in which the determination of terminal 102-m's geo-location is performed by an entity other than terminal 102-m itself.

Server 105 is a data-processing system that is capable of executing one or more software applications, of receiving and transmitting signals via telecommunications network 101, and of distributing the user-context-related information of the illustrative embodiment among the terminals involved. Although the illustrative embodiment comprises only server, it will be clear to those skilled in the art, after reading this disclosure, how to make and use alternative embodiments of the present invention that comprise any number of servers in any topology.

As part of its information distribution function, server 105 provides access to various databases, such as a geo-location database, a schedule database, a user profiles and preferences database, and so forth. The geo-location database comprises the current geo-location of one or more terminals, including at least some of the terminals depicted, as well as information concerning the geo-location of these terminals at various times in the past (i.e., geo-location histories).

The user-schedule database comprises the schedule information (e.g., meetings, vacations, etc.) for one or more users, in well-known fashion. As will be appreciated by those skilled in the art, in some embodiments of the present invention this information might be uploaded automatically from calendars stored in the users' telecommunications terminals.

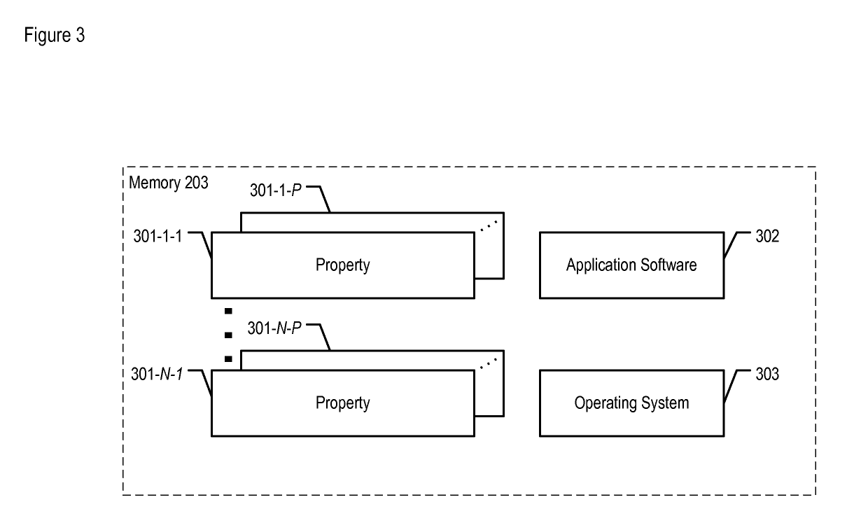

The user profiles and preferences database stores the user interface and user profile properties that are associated with each use context, for each user. Examples of these properties are described below and with respect to FIG. 3. The particular set of properties that is associated with each use context for a given user is predetermined in well-known fashion.

FIG. 2 depicts a block diagram of the salient components of telecommunications terminal 102-m, in accordance with the illustrative embodiment of the present invention. Telecommunications terminal 102-m comprises: transceiver 201, processor 202, memory 203, keypad 204, and video display 205, interconnected as shown.

Transceiver 201 comprises a receiving part and a transmitting part. The receiving part receives signals from telecommunications network 101, and forwards the information encoded in the signals to processor 202, in well-known fashion. The transmitting part receives information from processor 202, and outputs signals that encode this information to network 101, in well-known fashion. It will be clear to those skilled in the art, after reading this disclosure, how to make and use transceiver 201.

Processor 202 is a general-purpose processor that is capable of: receiving information from transceiver 201 and keypad 204; reading data from and writing data into memory 203; executing the tasks described below and with respect to FIG. 4; and transmitting information to transceiver 201 and video display 205. In some alternative embodiments of the present invention, processor 202 might be a special-purpose processor. In either case, it will be clear to those skilled in the art, after reading this disclosure, how to make and use processor 202.

Memory 203 is a non-volatile random-access memory that stores the instructions and data used by processor 202. Memory 203 stores the data that is described below and with respect to FIG. 3. It will be clear to those skilled in the art, after reading this disclosure, how to make and use memory 203.

Keypad 204 is a character and user-selection input device as is well-known in the art that receives input from a user (e.g., keystrokes, etc.) and transmits keypad signals representing that input. Keypad 204 comprises fixed function keys and soft keys, as are known in the art. It will be clear to those skilled in the art how to make and use keypad 204.

Video display 205 is a display output device as is well-known in the art that receives a video signal and creates a visual image of the signal for a user. It will be clear to those skilled in the art how to make and use video display 205.

FIG. 3 is a block diagram of how information is stored and organized in memory 203, in accordance with the illustrative embodiment of the present invention. The information stored in memory 203 comprises: use-context properties 301-n-p, for n=1 through N and for p=1 through P; application software 302; and operating system 303. As will be appreciated by those skilled in the art, the information that is stored in memory 203 can be organized differently from what is depicted in FIG. 3.

The use-context properties are related to the overall concept of use context, which is described here. The illustrative embodiment provides for the establishment of one use context over another at a given moment, in which a use context can be a personal context, a work context, and so forth. The establishment of the use context comprises, though is not necessary limited to, the application of one or more properties related to user interface or user profile, or both, at a telecommunications terminal (e.g., terminal 102-m, etc.). The user interface applied to a terminal is characterized by one or more properties that govern how a user interacts with: (i) the terminal, (ii) a call or calls handled by the terminal, and (ii) one or more data-processing systems accessible by the terminal, such as server 105 and the network nodes in network 101. The user profile applied to a terminal is characterized by one or more properties that govern a user's data and settings that are to be applied during a communication event (e.g., a telephone call, etc.).

By encompassing a user interface and user profile, a use context comprises, but is not limited to, one or more of the following properties:
i. how calls are presented to the user;
ii. the treatment that a user can apply to calls;
iii. the call-dependent features available to the user;
iv. the call-independent features available to the user;
v. how a user invokes the features;
vi. the number of accessible call appearances;
vii. the functions that are assigned to the terminal's soft keys;
viii. the menus available to the user;
ix. how the user accesses the menus;
x. the speed dialing list that applies;
xi. the set of contacts that applies;
xii. the set of action (“to do”) items that applies;
xiii. the set of appointments that applies;
xiv. the set of software applications that applies;
xv. the set of favorites, cookies, and/or call/browser history that applies;
xvi. the set of logins that applies;
xvii. the set of ringtones that applies; and
xviii. the set of terminal settings and tools that applies.

Property 301-n-p is a file structure that comprises information (i.e., one or more property values) that describes a particular characteristic of terminal 102-m's user interface or profile for a particular use context “n.” For example, property 301-4-2 might comprise information that represents a speed dial list for the “work” use context of terminal 102-m, while property 301-4-1 comprises information that represents a speed dial list associated with terminal 102-m's “personal” use context. In this example, the two sets of information would enable the user to have separate speed dial lists for work-related contacts (e.g., clients, tech support personnel, travel agents, pizza delivery, etc.) and for personal contacts (e.g., friends, family, movie times, pizza delivery, etc.), depending on the terminal's use context that is in effect.

Each use context combination of one or more properties and their values is presented to the user as a manifestation of that particular use context. For example, terminal 102-m's display will present one set of “to do” items (e.g., call the customer, attend the group meeting, etc.) to the user while in a work use context, while the display will present another set of “to do” items (e.g., pick up groceries, drive kids to soccer practice, etc.) to the user while in a personal use context.

For pedagogical purposes, two contexts are featured in the illustrative embodiment (i.e., N is equal to two), namely a “personal context” and a “work context”, in which the set of properties to be applied in the personal use context and the set of properties to be applied in the work use context are identical to each other. It should be noted that even in the illustrative examples disclosed within this specification, the actual information (e.g., the particular contacts, etc.) associated with each property (e.g., contact list, etc.) can be different across the two sets of properties. However, it will be clear to those skilled in the art, after reading this specification, how to make and use alternative embodiments that support a different number of use contexts than two. Furthermore, it will be clear to those skilled in the art, after reading this specification, how to make and use alternative embodiments in which the set of properties in a first use context is only partially overlapping—or, in fact, is non-overlapping—with the set of properties in a second use context, where the number of properties in each set are either the same or different.

In accordance with the illustrative embodiment and as depicted in FIG. 3, multiple sets of properties, one for each use context, are stored at terminal 102-1 simultaneously. From these multiple sets of properties, terminal 102-1 can select one set to present to the user, depending on the use context being put into effect. However, it will be clear to those skilled in the art, after reading this specification, how to make and use alternative embodiments in which some or all of the sets of properties are stored at a device other than terminal 102-1, such as server 105, until a particular set is needed at terminal 102-1.

Application software 302 represents the various, local software applications that the user of terminal 102-m may access, depending on the use context in effect. Operating system 303 is an operating system that performs input/output, file and memory management, and all of the other functions normally associated with operating systems, in well-known fashion. It will be clear to those skilled in the art how to make and use operating system 303.

FIG. 4 depicts a flowchart of the salient tasks as performed by terminal 102-m, in accordance with the illustrative embodiment of the present invention. As those who are skilled in the art will appreciate, in some alternative embodiments, only a subset of the depicted tasks is performed. In some other alternative embodiments, at least some of the tasks are performed simultaneously or in a different order from that depicted.

In accordance with the illustrative embodiment, it is terminal 102-1 that performs the tasks described below. However, as those who are skilled in the art will appreciate, another device depicted in FIG. 1 can perform the described tasks, such as:
i. a different terminal of the first user's terminals (e.g., terminal 102-2, etc.);
ii. a terminal of another user (e.g., terminal 103, etc.); or
iii. another device that is not a terminal (e.g., server 105, a network node that is part of network 101, etc.).

Furthermore, as those who are skilled in the art will appreciate, more than one device within telecommunications system 100 may concurrently perform the tasks disclosed herein, in order to establish and update the use context for that device's own user.

At task 401, terminal 102-1 receives one or more indications of spatial contexts. Indications of spatial context can include, while not being limited to, one or more of the following:
i. the terminal's current or past geo-location (precise position), or regional location (e.g., office room, home, etc.);
ii. its proximity to another terminal, a non-terminal device within or outside of system 100, a non-telecommunications object, or a person; and
iii. the other device's/object's/person's current or past geo-location or regional location.
   For example, terminal 102-1 can obtain its current geo-location in well-known fashion. As those who are skilled in the art will appreciate, an indication might reflect that a change in spatial context has occurred (e.g., a new geo-location relative to a previous geo-location, etc.).

At task 402, terminal 102-1 receives one or more indications of temporal contexts. Indications of temporal context can include, while not being limited to, one or more of the following:
i. the current time, either at the terminal or elsewhere;
ii. the current day/date, either at the terminal or elsewhere; and
iii. the time status with respect to an activities schedule.
   For example, terminal 102-1 can obtain the current date and time, either from its own clock or from an external source. As those who are skilled in the art will appreciate, an indication might reflect that a change in temporal context has occurred (e.g., a new time or date relative to a previous time or date, etc.).

At task 403, terminal 102-1 receives one or more indications of how its user is using, or will be using, the terminal. Indications can include, but are not limited to, one or more of the following:
i. the detection of keystrokes made by the user;
ii. the selection of one or more software applications;
iii. the accessing of one or more servers or other data-processing systems;
iv. the specifying by the user of a login;
v. the arrival of an incoming communication event;
vi. the initiation by the user of an outgoing communication event;
vii. the other party or parties involved in a communication event;
viii. the selection of a calling feature;
ix. the selection of a menu;
x. the selection of a contact or speed-dial item;
xi. the completion or execution of an action (“to do”) item; and
xii. the occurrence or cancellation of an appointment.
   For example, the arrival of an incoming telephone call can be treated as an indication that the user will be using terminal 102-1 to handle a call from another party. As those who are skilled in the art will appreciate, an indication might reflect that a change in terminal usage has occurred (e.g., a selection of a particular calling feature preceded by a selection of a particular contact, etc.).

As those who are skilled in the art will appreciate, terminal 102-1 is able to receive in parallel the one or more indications of spatial context, temporal context, and/or terminal usage as described above and with respect to tasks 401 through 403, respectively. Additionally, for a given iteration of the tasks described with respect to FIG. 4, terminal 102-1 might receive only a subset of the different types of indications (i.e., spatial context, temporal context, terminal usage), as opposed to receiving all three types of indications all of the time.

At task 404, terminal 102-1 establishes a use context to apply to the terminal, based on the one or more indications received at tasks 401, 402, and/or 403. In some embodiments, terminal 102-1 establishes a use context based on any changes in the indications received, with respect to indications previously received. In establishing a use context, terminal 102-1 selects a set of use-context properties to be put into effect at the terminal.

In some embodiments, in the event that terminal 102-1 establishes two (or more) different use contexts within a certain amount of time, the terminal arbitrates between the use contexts. For example, the terminal can settle on one of the possible use contexts by choosing a use context that was previously designated as the priority use context.

At task 405, terminal 102-1 presents, to its user, a manifestation of the use context that has been established at task 404. A manifestation can come in the form of something that is visual, audible, or tactile. For example, terminal 102-1 might display a list of appointments that is related to the use context that has been established. As another example, terminal 102-1 might explicitly notify its user of the use context established, either visually or audibly (e.g., “Work context is now in effect”, etc.).

At task 406, terminal 102-1 receives a user feedback from its user. The user feedback presumably indicates the user's reaction to having been presented with the particular use context that has been established. For example, the user might indicate that although the terminal has indicated that a work context is in effect, the user prefers or, in fact, insists that the personal context be put in effect.

At task 407, terminal 102-1 updates the use context that is in effect at the terminal, based on the user's feedback that is received. In some embodiments, terminal 102-1 applies the user's feedback of use context as is. In some other embodiments, the terminal applies the user's feedback, provided that other conditions are also met. In yet some other embodiments, the terminal can i) treat the user's feedback as merely a weight that is to be applied to future use context decisions, ii) defer the consideration of the user's feedback, iii) or ignore the user's feedback entirely with respect to updating a use context.

At task 408, terminal 102-1 transmits the use context to one or more other devices in telecommunications system 100. For example, server 105 might be sent the updated information, in order to maintain the terminal's current use context within a master database for some or all of the users. Terminals 102-2 through 102-M might be sent the updated information, in order to apply the appropriate use context to one or more of those terminals; in doing so, the other terminals might apply the same use context as in effect for terminal 102-1 or a complementary use context (e.g., work context for terminal 102-2 when personal context is in effect at terminal 102-1, etc.). And terminals of other users (e.g., terminals 103 and 104, etc.) might be sent the updated information as well.

After task 408, task execution proceeds back to task 401, in order to establish future use contexts as additional context-related and usage-related indications are received.

In some embodiments, the use context that is established might revert to another use context, such as a predetermined, preferred use context. The reversion might occur after the current communication event has finished, after a certain length of time, or based on another event having occurred.

As one may appreciate, there are many possible usage scenarios for the various embodiments of the invention, and a few of them are illustrated here. In a first example, terminal 102-l's user is at her residence, after typical work hours, but receives an urgent work communication event that requires her attention. When the user accesses the communication, terminal 102-1 notices that the urgent communication is from the user's supervisor, overrides the personal use context, and provides the user with the applications, contacts, and favorites that are needed to quickly and efficiently respond to the urgent work communication.

In a second example, terminal 102-1's user is determined, via a geo-location technique, to be traveling on a weekday during normal business hours. In accordance with the illustrative embodiment, the terminal determines that its user is using the terminal predominantly for personal use context activities. Terminal 102-1 switches to a personal use context and provides the applications, contacts, and favorites that are associated with such use.

In a third example, terminal 102-1's user in the United States is on a telephone call in the middle of the night. In accordance with the illustrative embodiment, the terminal receives an indication that the other call party is in India. As a result, terminal 102-1 switches to a work use context and provides the applications, contacts, and favorites that are associated with such use.

One who is skilled in the art can envision many other possible usage scenarios associated with the various embodiments of the present invention.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving i) a first indication of how a first user of a first telecommunications terminal is using or will be using the first telecommunications terminal and ii) a second indication of a spatial or temporal context that includes the first telecommunications terminal;
establishing a first use context to apply to the first telecommunications terminal, based on the first indication and the second indication; and
presenting a manifestation of the first use context to the first user at the first telecommunications terminal.

2. The method of claim 1 further comprising presenting the first use context to a second telecommunications terminal.

3. The method of claim 2 wherein the second telecommunications terminal is associated with the first user.

4. The method of claim 2 wherein the second telecommunications terminal is associated with a second user.

5. The method of claim 1 wherein the first use context is one of i) a work context and ii) a personal context.

6. The method of claim 5 further comprising receiving a user feedback from the first user, wherein the user feedback indicates the reaction of the first user to having been presented with the first use context.

7. The method of claim 6 further comprising establishing a second use context to apply to the first telecommunications terminal, based on having received the first user feedback, wherein the second use context is the other of i) the work context and ii) the personal context.

8. The method of claim 1 wherein the spatial or temporal context describes at least one of i) a geo-location of the first telecommunications terminal and ii) the current location of the first telecommunications terminal with respect to a second location.

9. The method of claim 1 wherein the spatial or temporal context describes at least one of i) calendrical time and ii) schedule information associated with the first user.

10. The method of claim 1 wherein the first indication is other than a notification of an incoming communication event.

11. A method comprising:
presenting a manifestation of a first use context to a first user at a first telecommunications terminal, the first use context being based on a first indication and a second indication, the first indication being of how the first user is using or will be using the first telecommunications terminal and the second indication describing a first spatial or temporal context that includes the first telecommunications terminal;
receiving a third indication of a second spatial or temporal context with respect to the first telecommunications terminal; and
establishing a second use context to apply to the first telecommunications terminal, based on the difference between the third indication and the second indication.

12. The method of claim 11 wherein the first use context is one of i) a work context and ii) a personal context.

13. The method of claim 12 wherein the first use context defines a first set of user-profile properties.

14. The method of claim 13 wherein the second use context is the other of i) the work context and ii) the personal context, and wherein the second use context defines a second set of user-profile properties.

15. The method of claim 14 wherein the first set and second set of user-profile properties are partially overlapping.

16. A method comprising:
establishing a first use context to apply to a first telecommunications terminal, the first use context being based on at least one of i) how the first user is using the first telecommunications terminal and ii) a spatial or temporal context that includes the first telecommunications terminal, and the first use context defining a first set of user-profile properties;
receiving i) a first indication of how the first user will be using the first telecommunications terminal or ii) a second indication as the result of the spatial or temporal context having changed; and
establishing a second use context to apply to the first telecommunications terminal, based on the first indication or second indication.

17. The method of claim 16 wherein the second use context defines a second set of user-profile parameters.

18. The method of claim 17 wherein the first set and second set of user-profile properties are at least partially overlapping.

19. The method of claim 18 wherein the first set of user-profile parameters comprises at least one of i) a set of contacts and ii) a set of applications.

20. The method of claim 18 wherein the first set of user-profile parameters comprises at least one of i) a set of action items and ii) a set of appointments.
